(19) United States
(12) Patent Application Publication
(10) Pub. No.: US 2005/0062613 A1
(43) Pub. Date: Mar. 24, 2005

(54) Location unit

(76) Inventors: Peter Sandberg, Spanga (SE); Johan Sandberg, Spanga (SE)

Correspondence Address: NIXON & VANDERHYE, PC, 1100 N GLEBE ROAD, 8TH FLOOR, ARLINGTON, VA, 22201-4714, US

(21) Appl. No.: 10/499,708

(22) PCT Filed: Dec. 17, 2002
(86) PCT No.: PCT/SE02/02357

(30) Foreign Application Priority Data
Dec. 19, 2001 (SE) 0104307-4

(51) Int. Cl. H04Q 7/00

(52) U.S. Cl. 340/825.72; 340/539.1

(57) ABSTRACT

A locating unit intended to be applied to an object and including a transmitter and a receiver of identifying radio frequency search signals, further comprising means by which it can function as a searcher, including a device for selecting objects to be located and for activating a search signal, also further comprising means by which it can function as an indicator, including a device for emitting an indicating signal at the reception of a search signal emitted by a second locating unit, cooperating with said first locating unit.

### TECHNICAL FIELD

The present invention relates to locating of certain objects. In particular, the invention relates to a locating unit, including a transmitter and a receiver, intended to be applied to objects which are desirable to locate. The invention also relates to a method of locating objects provided with the invented locating unit.

### BACKGROUND OF THE INVENTION AND PRIOR ART

Small objects which are valuable to their owner, such as, for example, a mobile phone, a bunch of keys, a pair of glasses or a wallet, are somtimes difficult to find, e.g. in the home, even though the owner knows that the objects are located somewhere nearby. It can be time consuming and sometimes impossible to locate them, which may cause a problem, especially when it is urgent. This may happen when going to work in the morning and there is no time to look for the missing object. Another problem, in case the object consists of the owners glasses, is that the owner may have difficulties locating the object by eyesight only, since the eyesight is limited without them.

Thus, there is a great demand for facilitating the location of certain valuable objects located within a limited area, such as, for example, a home.

In EP 0 089 667 this problem is solved by means of a unit comprising a transmitter of short range radio frequency signals, and one or more units comprising receivers of the signals and the emission of an indicating sound signal. These receiving units are intended to be attached to the objects to be located, for example a keyring.

A disadvantage with this prior art system is that the user must find the sending unit to be able to locate the lost object.

### SUMMARY OF THE INVENTION

The object of the present invention is to enable locating and supervision of certain objects of value for the owner, without the owner having to hold on to any special sending unit in order to perform the locating.

This object is achieved by the locating unit according to claim 1 and the methods of locating according to claims 8 and 11, enabling reciprocal locating or supervision of valuable objects. By means of this reciprocal locating, any of the objects provided with the invented locating unit can be located or supervised from any of the other objects also carrying such a locating unit, provided that the locating units are adapted to cooperate with each other.

The objects being desirable to locate or supervise are provided with a locating unit, comprising a transmitter and a receiver of identifying radio frequency search signals. The locating unit also comprises means by which it can function as a searcher, including a device by which the owner can select which object to locate and activate a search signal, and also means by which it can function as an indicator, including means for activating an indicating signal by which the object can be found.

The search signal may also be activated to be emitted at fixed intervals, which may be suitable when it is desirable to supervise objects and check that objects, provided with cooperating locating units, are not separated too far from each other.

The locating unit may be applied to a mobile phone by being integrated therewith. This mobile phone is preferably the owners regular mobile phone, which is provided with a transmitter and a receiver of radio frequency signals, for example a so-called Bluetooth.

When contact has been established between two locating units, an indicating light, sound or vibrating signal may be activated on the searched object, after which it can easily be found.

Thus, the invented locating unit can function both as a searcher and as an indicator, and it is intended to be applied to the valuable objects which are desirable to locate.

The device for selecting an object to be located and for activation of a continuously emitted search signal or a search signal emitted at fixed intervals, may be designed as a keypad.

The device for indicating that a searched object is located may include a display arranged on the unit. When the indication is activated, an indicating signal is emitted, primarily on the unit functioning as an indicator and which is attached to the searched object. Alternatively, indication may take place on the unit functioning as a searcher, by stating that contact is established with the indicating unit on the searched object.

Another possibility is that in indicating signal is emitted both on the searched and on the search locating unit when an indication is activated.

The indicating device may also include a sound- or light signal emitting means and/or a vibrating means.

In an invented method, locating of objects is performed, the objects being provided with the invented locating unit including a transmitter and a receiver of radio frequency signals. Reciprocal locating can be performed between objects provided with cooperating locating units by any one of them constituting the searched object, which is located by being selected on a first locating unit provided on any of the other objects. Thereby, this first locating unit functions as a searching unit and establishes a wireless contact with a second locating unit provided on the searched object, after which an indicating signal is activated. Thus, the second locating unit functions as an indicator.

One of the objects may comprise a mobile phone provided with a locating unit, such that the mobile phone is integrated with a locating unit.

An indicating signal may be activated on the searching locating unit as well, when contact is established between a searching locating unit and the indicating locating unit.

A second invented method relates to the supervision of one or more objects provided with a locating unit, by means of another object provided with a cooperating locating unit. In this case, a search signal is activated to be emitted at fixed intervals, and an indicating signal is activated when a search has resulted in that contact is not established, by which an alarm function is obtained.

By providing two or more of the owners valuable objects with the invented unit, the units being adapted to cooperate with each other, enabling the locating or supervising of a selectable object from each one of the other objects. Thereby, the owner does not have to hold on to any separate searching unit. It is likely that the owner always carries with him at least one of his valuable objects, by means of this which he will always be able to locate any one of the other objects.

### BRIEF DESCRIPTION OF THE DRAWINGS

The invention will be described in greater detail below, with reference to the FIGS. 1 and 2, of which

FIG. 1 shows a locating unit which is able to function both as a searcher and as an indicator, and

FIG. 2 shows a second embodiment of the invented locating unit, being integrated with a mobile phone.

### DETAILED DESCRIPTION OF THE INVENTION

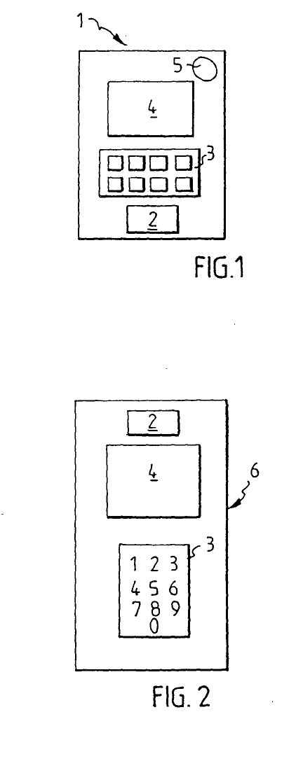

FIG. 1 illustrates a first embodiment of the invented locating unit 1, which is able to function both as a searcher and as an indicator. It can be applied to a valuable object, such as, for example, a bunch of keys, by means of a small hole 5 in a corner of the unit, in which a key ring can be attached. Other kinds of fastening means are also possible, such as a clamp or a Velcro®-fastening strip.

The locating unit showed in FIG. 1 is provided with a transmitter and a receiver of identifying, short range radio frequency signals, for example according to the so called Bluetooth-standard. These are available in the shape of small modules transmitting at the free ISM-frequency of approximately 2.4 Ghz. A Bluetooth transmitter has a relatively short range, which, however, is sufficient for searches in a home or at a place of work.

The locating units on the objects in question may be adapted to cooperate with each other by assigning an identity to each one of the different units, for example a number, to be used in the following way for searching a selected locating unit: By using the keypad 3, which the locating unit may be provided with, an object can be selected by means of its number, and a search signal can be activated, for example by one of the keys of the keypad, to contact a locating unit associated with the selected number. If the unit is provided with a display 4 as well, this may disclose which object that is to be searched. When the searched object has been located this may be indicated by a text or a flashing in the display of the searched locating unit. This indication may also occur on the searching locating unit. In this way, a message indicating that the searched object is located, for example, within a certain radius, can be seen on the object provided with the searching locating unit. The locating unit may also be provided with a sound emitting and vibrating means which is activated when a locating has taken place. By the aid of signals from these it is easy to find the object.

FIG. 2 shows a second embodiment of the invented locating unit, being integrated with a mobile phone 6. This may, for example, imply that the mobile phone is provided with a small Bluetooth-module 2, and that the ordinary keypad 3, display 4, ringing signals and any vibrations of the mobile phone are used during the search. Conveniently, an owner may use his regular mobile phone for searching other objects, which on their part are carrying locating units 1, provided that the mobile phone and the locating units are adapted to cooperate with each other.

When it is desirable to locate or supervise any of the objects provided with a locating unit 1, such as the one shown in FIG. 1, or a mobile phone 6 with a locating function as shown in FIG. 2, any of the objects on which cooperating locating units are applied can be used. On the keypad 3 of the locating unit/mobile phone the object to be searched can be selected. The different objects may preferably be coded with a number, such that the mobile phone may have number 1, the wallet may have number 2, the keys may have number 3 and the glasses number 4. When one wants to perform a search for the glasses, number 4 is selected on a locating unit applied to any of the other objects, and a search signal is activated. The search signal from this object now searches for an object being associated with number 4. When contact has been established with the locating unit applied to the glasses, an indicating signal is activated thereby, such as a flashing light on the display or on a separate indicator button, a sound signal and/or a vibrating signal. Guided by this signal, the owner should easily be able to find his glasses. An indicating signal may possibly be emitted on the searching locating unit as well.

Alternatively, the search signal may be activated to be emitted at fixed intervals, in order to supervise an object during a longer period of time and check that has not been removed outside the range of the search signal. In this case, the indicating signal is arranged to be activated in case contact is not established between the cooperating locating units, the indicating signal thereby constituting an alarm function.

The present invention is not limited to the above-described embodiments, but may be modified within the scope of the appended claims.

1. A locating unit, arranged to be applied to an object and comprising a transmitter and a receiver of identifying radio frequency search signals, wherein:
searching means for searching at least one other object provided with a second, cooperating locating unit, including a device for selecting an object to be located and for activating a search signal, and
indicating means, including a device for activating an indicating signal at the reception of a search signal emitted by a second, cooperating locating unit.

2. A locating unit according to claim 1, claim 1 the search signal can be activated to be emitted at fixed intervals for the supervision of objects.

3. A locating unit according to claim 1, wherein it is provided with a keypad for selecting objects to be located and for activating the search signal.

4. A locating unit according to claim 1, wherein it is provided with a display.

5. A locating unit according to claim 1, wherein it is provided with sound emitting means indicating that a searched object has been located.

6. A locating unit according to claim 1, wherein it is provided with vibrating means indicating that a searched object has been located.

7. A locating unit according to claim 1, wherein it is applied to a mobile phone by being integrated with the mobile phone.

8. A method of locating one or more objects, each being provided with a locating unit according to claim 1, wherein locating of the objects can be performed reciprocally, by any of them constituting a searched object which is located by way of the searched object being selected and a search signal activated on a first locating unit applied to any of the other objects, the first locating unit functioning as a searcher which wirelessly establishes contact with a second, cooperating locating unit applied to the searched object, the second locating unit functioning as an indicator and activates an indicating signal.

9. A method according to claim 8, wherein one of the objects comprises a mobile phone being integrated with a locating unit.

10. A method according to claim 8, wherein an indicating signal is activated both on the indicating locating unit and on the searching locating unit when contact is established between cooperating locating units.

11. A method for supervising one or more objects, each one provided with a locating unit according to claim 1, wherein a search signal is activated to be emitted at fixed intervals and that an indicating signal is activated when a search results in that no contact has been established.
